(19) United States
(12) Patent Application Publication
(10) Pub. No.: US 2017/0312906 A1
(43) Pub. Date: Nov. 2, 2017

(54) Length adjustment structure for wrench extension

(71) Applicant: Ting-Kai CHANG, Taichung City (TW)

(72) Inventor: Ting-Kai CHANG, Taichung City (TW)

(21) Appl. No.: 15/140,510

(22) Filed: Apr. 28, 2016

(51) Int. Cl. B25G 1/04; B25B 23/16

(52) U.S. Cl. CPC B25G 1/043; B25B 23/16

(57) ABSTRACT

A length adjustment structure contains: a body and a grip sleeve. The body includes a wrench extension, a driving head arranged on a front end of the wrench extension, a peripheral groove defined around a rear end of the wrench extension, a first retaining ring retained with the peripheral groove, and an accommodation orifice defined in the wrench extension so as to house a resilient element and a shaft. The grip sleeve is fitted with the wrench extension and includes a connection orifice defined in a front end thereof, a hollow portion therein behind and communicating with the fitting orifice, a surrounding trough arranged around an inner wall of the hollow portion adjacent to the connection orifice so as to accommodate a second retaining ring, and a tilted recess defined on the inner wall of the hollow portion behind the surrounding trough.

### FIELD OF THE INVENTION

The present invention relates to a length adjustment structure which is capable of adjusting an extending distance of the wrench extension and the grip sleeve randomly by using the first retaining ring and the second retaining ring.

### BACKGROUND OF THE INVENTION

A conventional length adjustment structure for a wrench extension contains a locking ball fixed on the wrench extension, and a plurality of retaining recess defined on an inner wall of a hollow portion of a grip sleeve at a fixed interval, such that as adjusting a distance between the wrench extension and the grip sleeve, the locking ball retains with one of the plurality of retaining recesses.

However, the plurality of retaining recess are defined on an inner wall of a hollow portion of a grip sleeve at the fixed interval, so the distance between the wrench extension and the grip sleeve cannot be adjusted randomly.

The present invention has arisen to mitigate and/or obviate the afore-described disadvantages.

### SUMMARY OF THE INVENTION

The primary objective of the present invention is to provide a length adjustment structure which is capable of adjusting an extending distance of the wrench extension and the grip sleeve randomly by using the first retaining ring and the second retaining ring.

To obtain above-mentioned objective, a length adjustment structure provided by the present invention contains: a body and a grip sleeve.

The body includes a wrench extension, a driving head arranged on a front end of the wrench extension, a peripheral groove defined around an outer wall of a rear end of the wrench extension, a first retaining ring retained with the peripheral groove, and an accommodation orifice defined in the wrench extension in front of the peripheral groove so as to house a resilient element and a shaft.

The grip sleeve is fitted with a rear end of the wrench extension and includes a connection orifice defined in a front end thereof, a hollow portion therein behind and communicating with the fitting orifice, a surrounding trough arranged around an inner wall of the hollow portion adjacent to the connection orifice so as to accommodate a second retaining ring, and a tilted recess defined on the inner wall of the hollow portion behind the surrounding trough.

Preferably, after the wrench extension is pulled to move away from the grip sleeve, the shaft of the wrench extension retains into the tilted recess of the grip sleeve and pushes the resilient element outwardly so as to obtain a maximum extending distance of the wrench extension and the grip sleeve.

Preferably, the wrench extension is inserted into the connection orifice of the grip sleeve so as to fit with the hollow portion.

### BRIEF DESCRIPTION OF THE DRAWINGS

FIG. 1 is a perspective view showing the assembly of a length adjustment structure for a wrench extension according to a preferred embodiment of the present invention.

FIG. 2 is a perspective view showing the exploded components of the length adjustment structure for the wrench extension according to the preferred embodiment of the present invention.

FIG. 3 is a cross sectional view showing the operation of the length adjustment structure for the wrench extension according to the preferred embodiment of the present invention.

FIG. 4 is a perspective view showing the operation of the length adjustment structure for the wrench extension according to the preferred embodiment of the present invention.

FIG. 5 is another cross sectional view showing the operation of the length adjustment structure for the wrench extension according to the preferred embodiment of the present invention.

### DETAILED DESCRIPTION OF THE PREFERRED EMBODIMENTS

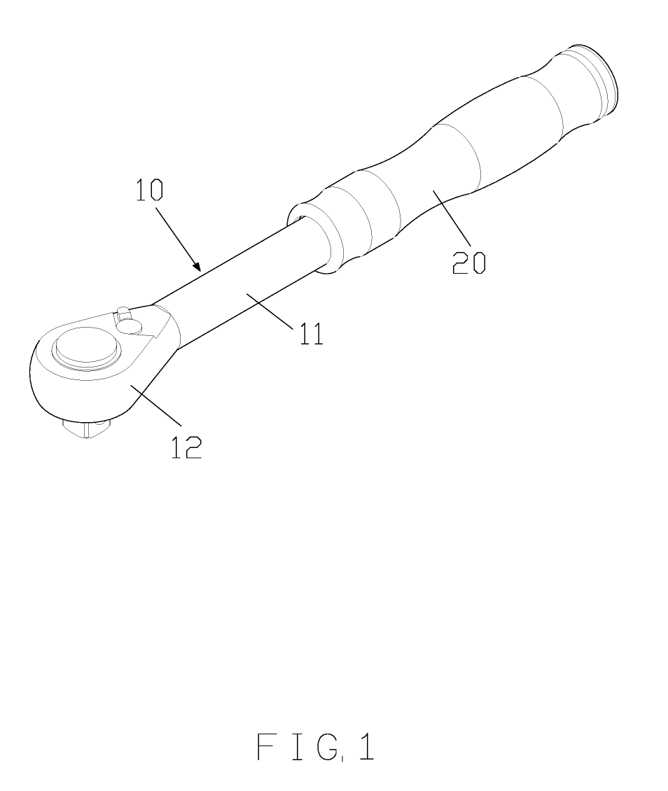

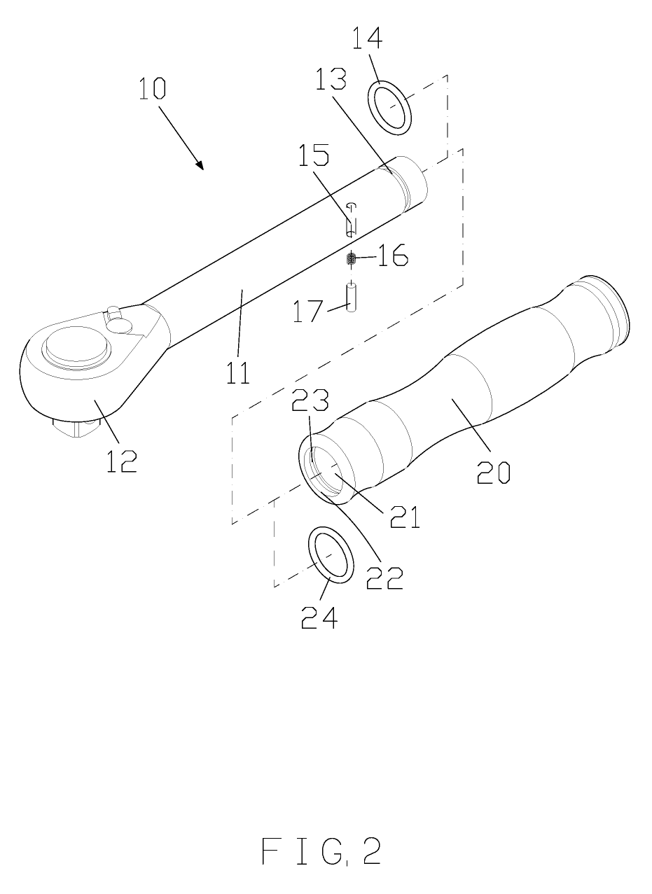

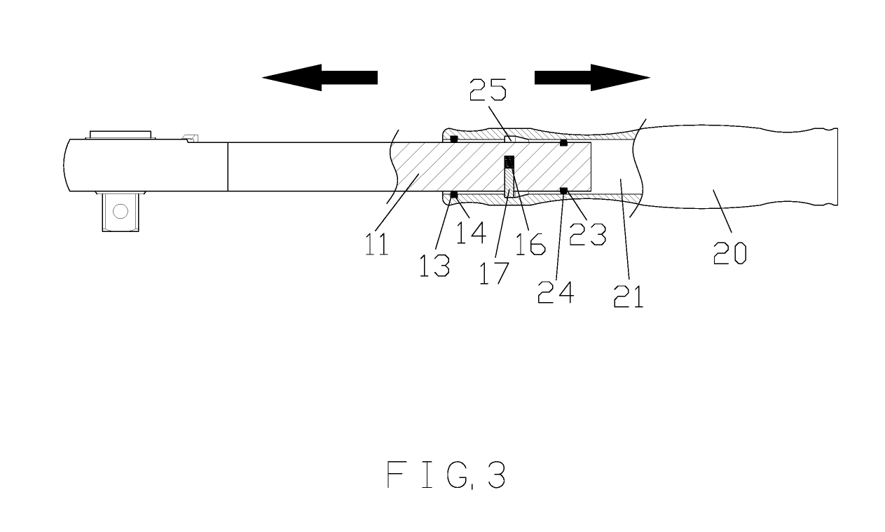

With reference to FIGS. 1 to 3, a length adjustment structure for a wrench extension 11 according to a preferred embodiment of the present invention comprises: a body 10, and the body 10 includes a wrench extension 11, a driving head 12 arranged on a front end of the wrench extension 11, a peripheral groove 13 defined around an outer wall of a rear end of the wrench extension 11, a first retaining ring 14 retained with the peripheral groove 13, and an accommodation orifice 15 defined in the wrench extension 11 in front of the peripheral groove 13 so as to house a resilient element 16 and a shaft 17.

The rear end of the wrench extension 11 fits with a grip sleeve 20, and the grip sleeve 20 includes a connection orifice 22 defined in a front end thereof, a hollow portion 21 therein behind and communicating with the fitting orifice 22, a surrounding trough 23 arranged around an inner wall of the hollow portion 21 adjacent to the connection orifice 22 so as to accommodate a second retaining ring 24, and a tilted recess 25 defined on the inner wall of the hollow portion 21 behind the surrounding trough 23.

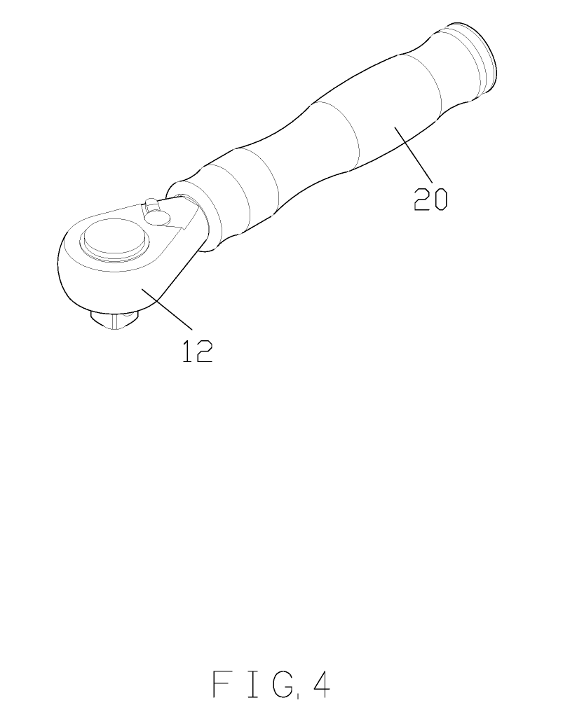

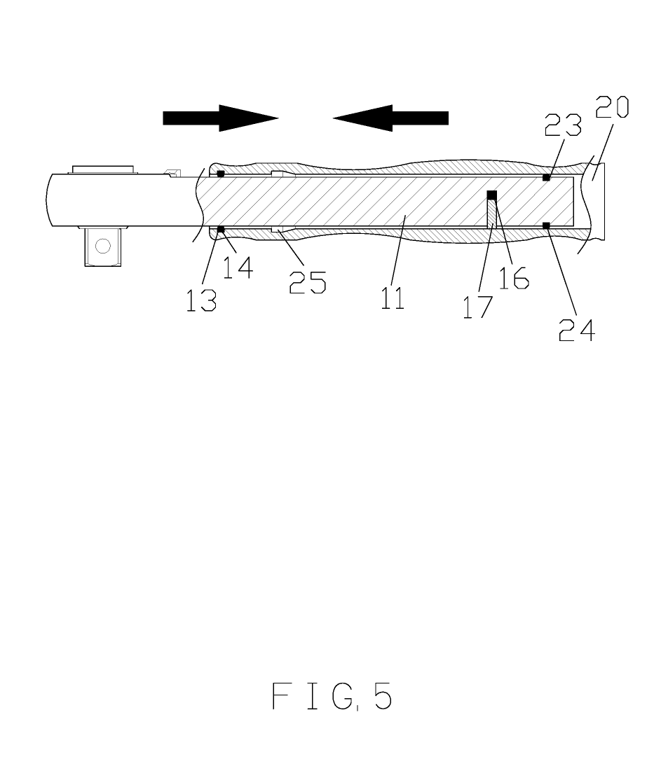

Referring to FIGS. 1 and 3-5, the wrench extension 11 is inserted into the connection orifice 22 of the grip sleeve 20 so as to fit with the hollow portion 21, wherein after the wrench extension 11 is pulled to move away from the grip sleeve 20, the shaft 17 of the wrench extension 11 retains into the tilted recess 25 of the grip sleeve 20 and pushes the resilient element 16 outwardly, thus obtaining a maximum extending distance of the wrench extension 11 and the grip sleeve 20. When the wrench extension 11 is pushed to move close to the grip sleeve 20, the first retaining ring 14 and the second retaining ring 24 abut against the inner wall of the hollow portion 21 and the wrench extension 11, thus retracting the wrench extension 11 inwardly.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A length adjustment structure comprising:
a body, and the body including a wrench extension, a driving head arranged on a front end of the wrench extension, a peripheral groove defined around an outer wall of a rear end of the wrench extension, a first retaining ring retained with the peripheral groove, and an accommodation orifice defined in the wrench extension in front of the peripheral groove so as to house a resilient element and a shaft;
a grip sleeve fitted with a rear end of the wrench extension, and the grip sleeve including a connection orifice defined in a front end thereof, a hollow portion therein behind and communicating with the fitting orifice, a surrounding trough arranged around an inner wall of the hollow portion adjacent to the connection orifice so as to accommodate a second retaining ring, and a tilted recess defined on the inner wall of the hollow portion behind the surrounding trough.

2. The length adjustment structure as claimed in claim 1, wherein after the wrench extension is pulled to move away from the grip sleeve, the shaft of the wrench extension retains into the tilted recess of the grip sleeve and pushes the resilient element outwardly so as to obtain a maximum extending distance of the wrench extension and the grip sleeve.

3. The length adjustment structure as claimed in claim 1, wherein the wrench extension is inserted into the connection orifice of the grip sleeve so as to fit with the hollow portion.
